(19) United States
(12) Patent Application Publication
(10) Pub. No.: US 2023/0390856 A1
(43) Pub. Date: Dec. 7, 2023

(54) WELDING GUN

(71) Applicant: Obara Corporation, Fuefuki-shi (JP)

(72) Inventors: Takehiro Izumi, Fuefuki-shi (JP); Takashi Terada, Fuefuki-shi (JP); Toshirou Jou, Fuefuki-shi (JP)

(21) Appl. No.: 18/328,531

(22) Filed: Jun. 2, 2023

(30) Foreign Application Priority Data
Jun. 7, 2022 (JP) 2022-092232

(51) Int. Cl. B23K 11/11

(52) U.S. Cl. CPC B23K 11/115

(57) ABSTRACT

A welding gun includes a fixed electrode fixed to an arm, a movable electrode held by a holding member separated from the arm, a pressure driver including a rod portion that is fixed to the holding member, and linearly advances and retracts. The pressure driver applies pressure to a welding target sandwiched between the movable electrode and the fixed electrode by advancing the holding member to the arm with the rod portion, and a guide mechanism that is disposed to extend parallel to an axis of the rod portion, and guides the holding member. The rod portion is fixed to the holding member to be offset to an extended line of an axis of the fixed electrode, and the guide mechanism includes only one guide rod fixed to any of movable portions including the movable electrode, the holding member, and the rod portion.

### CROSS-REFERENCE TO RELATED APPLICATION

The present application is based on and claims priority from Japanese Patent Application No. 2022-092232 filed on Jun. 7, 2022, the disclosure of which is hereby incorporated by reference in its entirety.

### FIELD OF THE INVENTION

The present disclosure relates to a welding gun.

### BACKGROUND

A welding gun for use in resistance spot welding includes a fixed electrode and a movable electrode arranged to face each other, and is configured to advance and retract the movable electrode to the fixed electrode fixed to an arm by a pressure driver. In such a welding gun, the pressure driver advances the movable electrode to the fixed electrode, applies pressure to the welding target disposed between the fixed electrode and the movable electrode by sandwiching the welding target with the both electrodes, and flows larger current between the both electrodes in a short time. The welding gun thereby welds the welding target (e.g., see JP2001-025877A).

The pressure driver includes a linearly displaceable rod portion, and the rod portion moves the movable electrode toward the fixed electrode to advance and retract the movable electrode. The welding gun may include a rotation stop mechanism of preventing the rod portion from rotating about an axis by a reaction force, for example, when applying pressure to the welding target by sandwiching the welding target with the movable electrode and the fixed electrode.

In a welding gun in which a movable electrode is held by a holding member, and a rod portion is fixed to the holding member to be offset from an extended line of an axis of a fixed electrode, the rod portion presses the holding member offset from a position where the welding target is sandwiched by the leading end of the fixed electrode and the leading end of the movable electrode, so that the rod portion bends.

That is, when the holding member receives a backward reaction from the fixed electrode on the axis to which the movable electrode is fixed, and receives a forward load from the rod portion on the axis to which the rod portion presses, moment occurs on the holding member, and the holding member rotates by the movement, so that the rod portion bends.

As a result, the movable electrode may be misaligned from the fixed electrode, and welding pressure generated in the pressure driver may not properly act on the welding target.

It is, therefore, proposed a welding gun that prevents a movable electrode from being misaligned by controlling the bending of a holding member. In this case, the movable member is prevented from being misaligned by supporting the holding member with a guide mechanism having two round bar guide rods provided in two positions at a predetermined interval along the width direction different from the position where the rod portion is fixed.

However, as the two round bar guide rods are arranged in parallel in the width direction, the welding gun increases its size in the width direction, and thus, the use range in which the welding gun is movable is largely limited.

An object of the present disclosure is to provide a welding gun having the above-described guide mechanism and a reduced size in the width direction.

### SUMMARY

To achieve the object, the present disclosure provides a welding gun including a fixed electrode fixed to an arm, a movable electrode held by a holding member separated from the arm, a pressure driver including a rod portion that is fixed to the holding member, and linearly advances and retracts, the pressure driver applying pressure to a welding target sandwiched between the movable electrode and the fixed electrode by advancing the holding member to the arm with the rod portion, and a guide mechanism that is disposed to extend parallel to an axis of the rod portion, and guides the holding member, wherein the rod portion is fixed to the holding member to be offset to an extended line of an axis of the fixed electrode, and the guide mechanism includes only one guide rod fixed to any of movable portions including the movable electrode, the holding member, and the rod portion.

### BRIEF DESCRIPTION OF DRAWINGS

FIG. 1 is a perspective view illustrating a welding gun of a first embodiment.

FIG. 2 is a longitudinal sectional view of the welding gun in FIG. 1.

FIG. 3 is a partial sectional perspective view illustrating a structure of a ball spline in the welding gun.

FIG. 4 is a perspective view illustrating a welding gun of a second embodiment.

FIG. 5 is a longitudinal sectional view of the welding gun in FIG. 4.

### DETAILED DESCRIPTION

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

Hereinafter, an embodiment of a welding gun according to the present disclosure will be described with reference to the drawings.

### First Embodiment

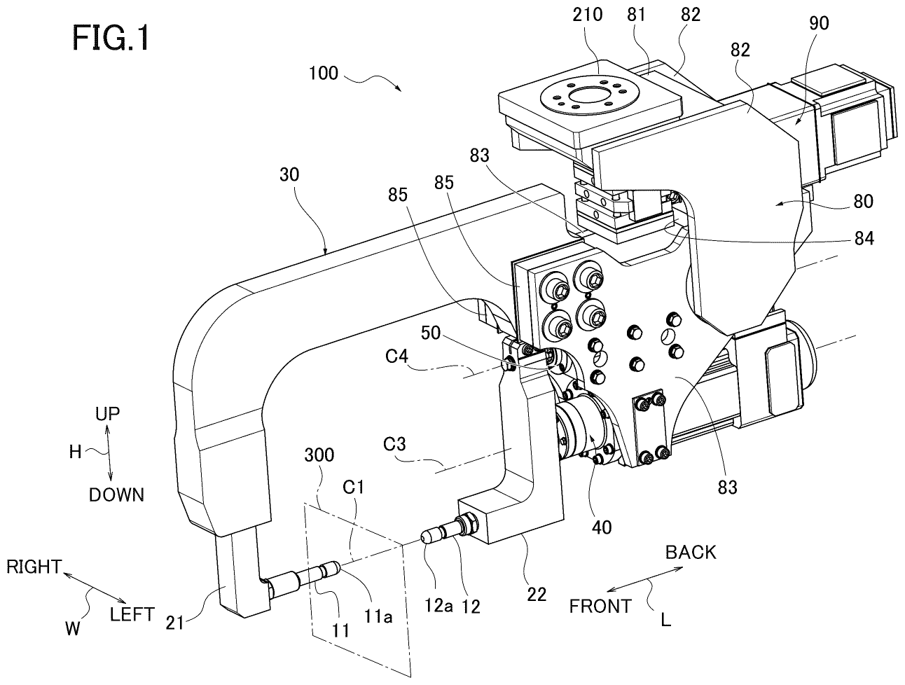

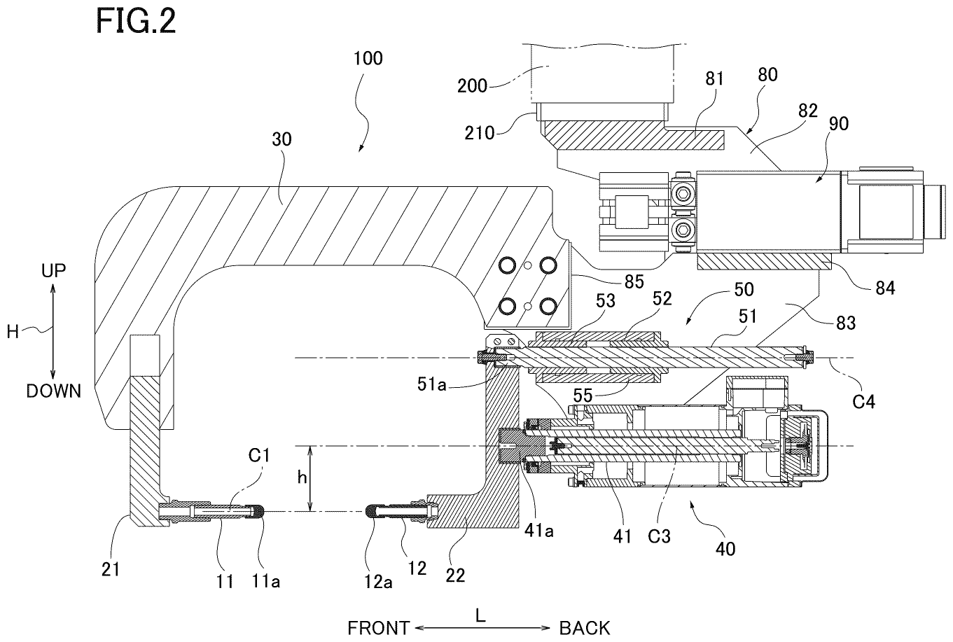

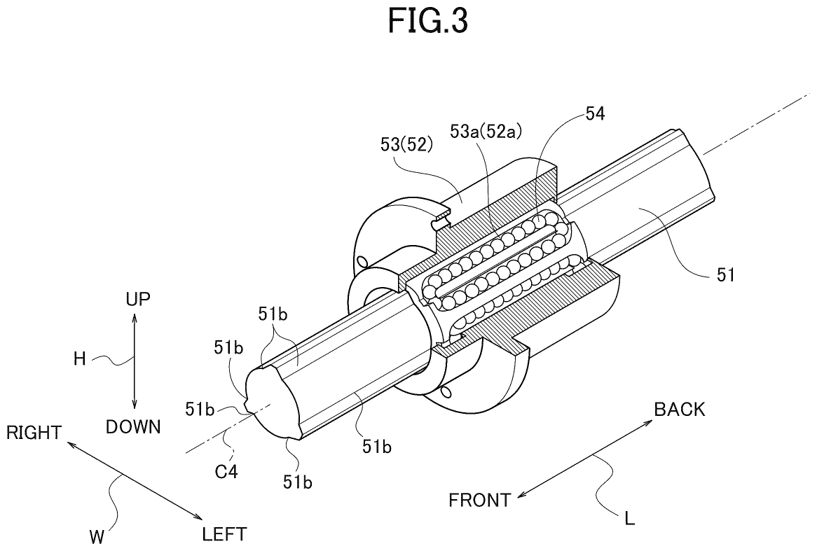

A configuration of a welding gun will be hereinafter described. FIG. 1 is a perspective view illustrating a welding gun 100 of the first embodiment. FIG. 2 is a longitudinal sectional view of the welding gun 100 in FIG. 1. FIG. 3 is a partial sectional perspective view illustrating a structure of a ball spline 50 in the welding gun 100. The illustrated welding gun 100 is one embodiment of the welding gun according to the present disclosure.

The welding gun 100 is a gun for resistance spot welding, and is a so-called C-shaped gun having a C-shaped arm 30 as illustrated in FIG. 1. The welding gun 100 includes a fixed electrode 11, a movable electrode 12, holders 21, 22, the arm 30, a pressure driver 40, the ball spline 50, a support member 80, and a transformer 90.

In the welding gun 100, the support member 80 is fixed to the arm 30, and the pressure driver 40, the ball spline 50, and the transformer 90 are fixed to the support member 80. The fixed electrode 11 is fixed to the arm 30, and the movable electrode 12 is attached to the pressure driver 40.

More specifically, the fixed electrode 11 is fixed to the arm 30 through the holder 21 attached to one end of the C-shaped arm 30. A replaceable electrode tip 11a is attached to the leading end of the fixed electrode 11.

The movable electrode 12 is fixed to the holder 22 (holding member) separated from the arm 30. The holder 22 is displaceable to the arm 30, and the holder 22 is displaced to the arm 30 to advance and retract the movable electrode 12 to the fixed electrode 11. The movable electrode 12 is disposed such that its axis is located on an extended line of an axis C1 of the fixed electrode 11. A detachable electrode tip 12a is also attached to the leading end of the movable electrode 12.

The pressure driver 40 includes a rod portion 41. A front leading end 41a of the rod portion 41 in a front and back direction L is fixed to the holder 22 be offset to the extended line of the axis C1. The pressure driver 40 linearly advances and retracts the rod portion 41 along an axis C3 parallel to the axis C1. As illustrated in FIG.2, the axis C3 of the rod portion 41 is offset upward to the axis C1 of the fixed electrode 11 by a height h in a height direction H.

The ball spline 50 is one example of the guide mechanism that guides the holder 22, and has a high rigidity (strong strength) to the bending in the direction intersecting with the longitudinal direction (direction along axis C4).

The ball spline 50 includes a single spline shaft 51 (one example of guide rod), two outer casings 52, 53, and a ball 54 (refer to FIG. 3). As illustrated in FIG. 3, the spline shaft 51 has, on an outer circumference surface thereof, two or more paths 51b each linearly extending along an axis C4. This path 51b may be formed as a projection inclination surface projecting on the outer circumference surface as illustrated in FIG. 3 or may be formed as a groove surface that is different from that in FIG. 3 and is formed on the outer circumference surface.

The path 51b has an arc section with a diameter substantially the same as that of the outer surface (spherical surface) of the ball 54. Accordingly, the spline shaft 51 has a so-called modified section with a non-perfect circle of a sectional contour by a plane orthogonal to the axis C4. The single spline shaft 51, therefore, has a rigidity (strength) to the bending in the direction intersecting with the longitudinal direction higher (stronger) than that of a true circle round bar with the minimum radius in section.

The front leading end 51a of the spline shaft 51 in the front and back direction L is fixed to the holder 22. The leading end 51a of the spline shaft 51 is fixed to the holder 22 above the axis C3 to which the rod portion 41 is fixed in the height direction H. That is, the spline shaft 51 is fixed to the holder 22 to be opposite to the movable electrode 12 across the rod portion 41.

The two outer casings 52, 53 are arranged in parallel along the axis C4 direction of the spline shaft 51. Each of the two outer casings 52, 53 is fixed to a frame case 55 to be integrated.

The outer casing 53 (similar to outer casing 52) has on an inner circumference surface thereof a circuit 53a (52a) that circulates a plurality of balls 54 rotating along the path 51b of the spline shaft 51 as illustrated in FIG. 3.

When the spline shaft 51 is displaced along the axis C4 relative to the outer casings 53, 52 fixed to the frame case 55, a plurality of balls 54 disposed between the path 51b of the spline shaft 51 and the circuits 53a, 52a of the outer casings 53, 52 move while rotating in the circuits 53a, 52a along the movement of the spline shaft 51 to linearly displace the spline shaft 51 along the axis C4 with high accuracy.

The spline shaft 51 is covered by the outer casings 52, 53 having a certain length in the longitudinal direction through many balls 54 arranged in parallel in the longitudinal direction. The ball spline 50 thereby has a rigidity to the bending higher than that of a simple guide rod.

The support member 80 includes a top board 81, two upper side boards 82, two lower side boards 83, a middle board 84, and two spacers 85.

The top board 81 is a platelike body horizontally (plane expanding in width direction W and front and back direction L) disposed on the top part of the support member 80 in the height direction H. The top board 81 is fixed to an attachment member 210 that attaches the welding gun 100 to a robot arm 200.

The middle board 84 is a platelike body horizontally disposed below the top board 81 similar to the top board 81. The transformer 90 that supplies power to the fixed electrode 11 and the movable electrode 12 is fixed to the upper surface of the middle board 84.

The two lower side boards 83 are platelike bodies vertically (plane expanding in height direction H and front and back direction L) disposed on the right and left both sides, respectively, in the width direction W across the axes C3, C4.

The two lower side boards 83 fix the middle board 84 while sandwiching the middle board 84 by the upper portions in the height direction H and the back portions in the front and back direction L from the outside in the width direction W. The two lower side boards 83 also fix the arm 30 through the spacers 85, 85 while sandwiching the arm 30 by the upper portions in the height direction H and the front portions in the front and back direction L from the outside in the width direction W. The two lower side boards 83 fix the arm 30 such that the axis C1 of the fixed electrode 11 is parallel to the front and back direction L.

The two lower side boards 83 fix the pressure driver 40 while sandwiching the pressure driver 40 by the lower portions in the height direction H from the outside in the width direction W. The two lower side boards 83 fix the main body (e.g., case portion except rod portion 41) of the pressure driver 40 such that the axis C3 of the pressure driver 40 is parallel to the front and back direction L.

The two lower side boards 83 fix the frame case 55 of the ball spline 50 while sandwiching the frame case 55 between the upper portions and the lower portions in the height direction H from the outside in the width direction W. The two lower side boards 83 fix the ball spline 50 such that the axis C4 of the spline shaft 51 is parallel to the front and back direction L. As described above, the ball spline 50 and the pressure driver 40 are integrated through the lower side boards 83, but are not directly fixed.

The arm 30, the pressure driver 40, and the ball spline 50 are fixed to the two lower side boards 83 as described above, so that the axis C1 of the fixed electrode 11, the axis C3 of the pressure driver 40, and the axis C4 of the ball spline 50 are disposed parallel to each other and in the same vertical plane (plane expanding in height direction H and front and back direction L).

The two upper side boards 82 fix the top board 81 while sandwiching the top board 81 by the upper portions in the height direction H from the outside in the width direction W, and fix the two lower side boards 83 while sandwiching the two lower side boards 83 by the lower portions in the height direction H from the outside in the width direction W.

An operation of the welding gun 100 configured as described above will be hereinafter described.

When the top board 81 of the support member 80 is fixed to the attachment member 210 that is attached to the robot arm 200, the welding gun 100 is fixed to the robot arm 200. The position and the posture of the welding gun 100 relative to the welding target 300 are thereby adjusted according to the movement of the robot arm 200.

As illustrated in FIG. 1, the robot arm 200 controls the position and the posture of the welding gun 100 to dispose the welding target 300 between the electrode tip 11a of the fixed electrode 11 and the electrode tip 12a of the movable electrode 12.

The welding gun 100 has a not-shown controller. The controller controls the pressure driver 40 to move the rod portion 41 forward in the front and back direction L along the axis C3. The holder 22 fixed to the rod portion 41 thereby advances the movable electrode 12 toward the fixed electrode 11 along the axis C1.

At this time, the spline shaft 51 having the leading end 51a fixed to the holder 22 advances to the outer casings 52, 53 fixed to the support member 80 along the axis C4 in accordance with the advancing of the holder 22.

When the movable electrode 12 advances, the electrode tip 11a of the fixed electrode 11 and the electrode tip 12a of the movable electrode 12 face each other on the extended line of the axis C1 across the welding target 300.

When the pressure driver 40 applies pressure to the rod portion 41 to further advance the rod portion 41 while sandwiching the welding target 300 between the electrode tip lla of the fixed electrode 11 and the electrode tip 12a of the movable electrode 12, the fixed electrode 11 and the movable electrode 12 strongly sandwich the welding target 300 by a predetermined load to be pressurized.

At this time, a part of the holder 22 on the axis C3 receives the forward welding pressure from the rod portion 41 while a part of the holder 22 on the axis C1 receives the backward reaction from the fixed electrode 11. The moment that rotates in the counterclockwise direction thereby occurs in the holder 22 in FIG. 2. If the holder 22 rotates by this moment, the leading end 41a of the rod portion 41 fixed to the part of the holder 22 on the axis C3 bends downwardly. In this case, the electrode tip 12a of the movable electrode 12 is misaligned downwardly from the axis C1.

In contrast, in the welding gun 100 of the present embodiment, the ball spline 50 provided along the axis C4 parallel to the axis C1 of the rod portion 41 is fixed to the holder 22. It is therefore necessary to bend not only the rod portion 41 but also the ball spline 50 for rotating the holder 22.

However, the ball spline 50 has a high rigidity that prevents the holder 22 from rotating cooperatively with the rod portion 41. The rod portion 41 and the ball spline 50 thereby do not bend, the rod portion 41 maintains its shape along the axis C3, and the ball spline 50 maintains its shape along the axis C4.

The holder 22 is thereby prevented from rotating, and also the electrode tip 12a of the movable electrode 12 is prevented from being misaligned from the position on the axis C1. As a result, the welding gun 100 appropriately applies the welding pressure generated by the pressure driver 40 to the welding target 300.

In the welding gun 100, the controller controls the transformer 90 to flow current between the fixed electrode 11 and the movable electrode 12 while appropriately applying the welding pressure to the welding target 300 with the movable electrode 12 and the fixed electrode 11 as described above. The welding gun 100 thereby welds the welding target 300.

As described above, according to the welding gun 100 of the present embodiment, with the configuration in which the ball spline 50 as one example of the guide mechanism having high rigidity is provided in the holder 22 to which the rod portion 41 and the movable electrode 12 are fixed, the movable electrode 12 can be appropriately prevented from being misaligned.

With the configuration in which only one ball spline 50 is provided in the same plane as the axis C1 of the two electrodes 11, 12 and the axis C3 of the pressure driver 40 (rod portion 41), the welding gun 100 of the present embodiment can reduce its size along the width direction W of the welding gun 100 smaller than that in which two or more guide rods are disposed separately in the width direction W. The welding gun 100 can thereby reduce the limitation of the use range by moving.

With the configuration in which the axis C1, the axis C3, and the axis C4 are disposed in the same plane, the welding gun 100 of the present embodiment can effectively obtain the effect that controls the misalignment. More specifically, with the configuration in which the axis C1, the axis C3, and the axis C4 are disposed in the same plane, the welding gun 100 increases the rigidity to the load along the height direction H in the plane including the axis C1, the axis C3, and the axis C4, so that the welding gun 100 can improve the effect that controls the downward misalignment in the height direction H.

In the welding gun 100 of the present embodiment, the frame case 55 of the ball spline is fixed to the lower side board 83 (support member 80) without being directly fixed to the pressure driver 40. With this configuration, the distance in the height direction H between the rod portion 41 of the pressure driver 40 and the spline shaft 51 can be adjusted by adjusting the fixed position of the frame case 55 in the lower side board 83.

In this case, although the load that acts to bend the rod portion 41 is increased when the configuration in which the height h that is the offset amount from the axis C1 of the electrodes 11, 12 to the axis C3 to which the rod portion 41 is fixed is adopted, the strength by the ball spline 50 facing the load that bends the rod portion 41 can be increased by adjusting the distance in the height direction H from the axis C1 to the axis C4 to which the ball spline 50 is fixed to be increased. The misalignment of the movable electrode 12 can be thereby controlled.

When the frame case 55 is fixed to the lower side board 83 with a bolt, for example, a hole of the lower side board 83 through which the bolt penetrates may be formed as a long hole extending in the height direction H or a plurality of holes arranged along the height direction H. With this configuration, the distance in the height direction H between the rod portion 41 of the pressure driver 40 and the spline shaft 51 can be adjusted easier than the case in which the frame case 55 is directly fixed to the pressure driver 40.

However, the welding gun according to the present disclosure may be a welding gun in which the guide mechanism (ball spline 50 as one example) is directly fixed to the pressure driver 40 without excluding the welding gun in which the guide mechanism is fixed to the pressure driver 40.

In the welding gun 100 of the present embodiment, as one example, the single ball spline 50 is adopted as the guide mechanism having high rigidity. However, the welding gun according to the present disclosure is not limited to the welding gun in which the ball spline 50 is adopted as the guide mechanism having a high rigidity.

More specifically, as long as the welding gun according to the present disclosure includes a single guide rod having the axis C4 extending parallel to the axis C3 of the rod portion 41 in the plane including at least the axis C1 of the movable electrode 12 and the axis C3 of the rod portion 41 as the guide mechanism having high rigidity, a guide mechanism including only one guide rod having a modified sectional contour that is not a non-perfect circle, for example, may be adopted.

In this case, the welding gun according to the present disclosure, with the configuration in which the axis C1, the axis C3, and the axis C4 are arranged in the same plane, the misalignment can be effectively controlled.

As described above, the welding gun in which the guide mechanism including a single guide rod having a modified sectional contour in the plane including the axis C1 of the movable electrode 12 and the axis C3 of the rod portion 41 can appropriately support the movable electrode 12, and also can reduce its size along the width direction W of the welding gun 100 to reduce the limitation of the use range by moving the welding gun 100.

In the welding gun 100 of the present embodiment, the support member 80 is divided into the upper side board 82 and the lower side board 83 in the height direction H. However, the support member 80 is not limited thereto, and the upper side board 82 and the lower side board 83 may be integrated.

In the welding gun 100 of the present embodiment, as one example, the spline shaft 51 of the ball spline 50 is fixed to the holder 22. However, the welding gun 100 according to the present disclosure is not limited thereto as long as the guide rod of the guide mechanism in the welding gun 100 according to the present disclosure is fixed to any of the movable portions that move relative to the arm. The movable portions include the movable electrode, the holding member, and the rod portion. Accordingly, the welding gun 100 may be a welding gun in which the spline shaft 51 is fixed to the movable electrode 12 or to the rod portion 41. It is similar in the following second embodiment.

### Second Embodiment

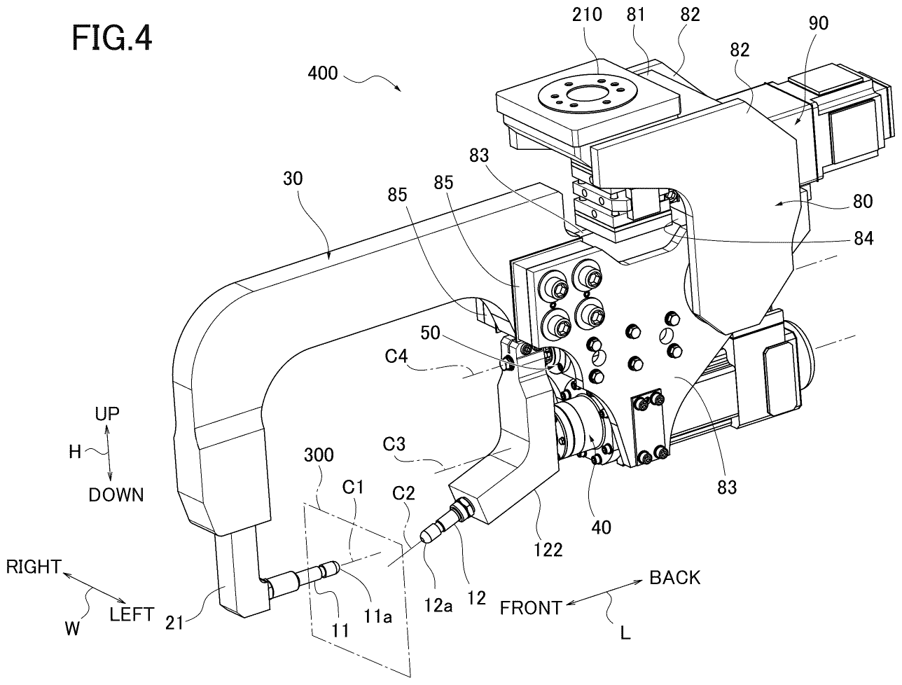

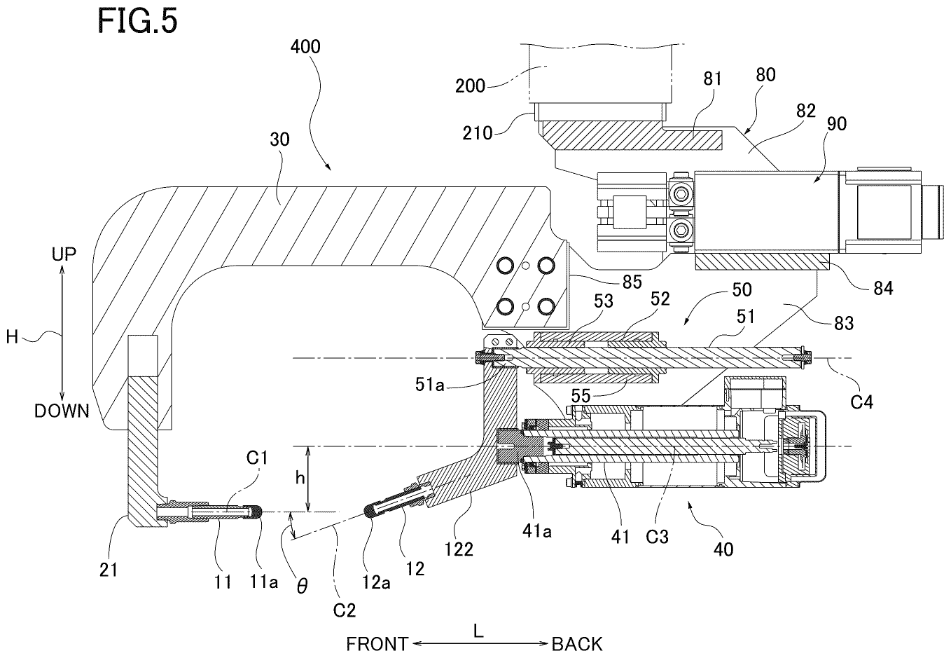

A configuration of a second embodiment will be hereinafter described. FIG. 4 is a perspective view illustrating a welding gun 400 of the second embodiment. FIG. 5 is a longitudinal sectional view of the welding gun 400 in FIG. 4. The illustrated welding gun 400 is another embodiment of the welding gun according to the present disclosure.

The welding gun 400 has the same basic configuration as the welding gun 100 of the first embodiment, and differs from the welding gun 100 of the first embodiment in that the welding gun 400 includes a holder 122 instead of the holder 22, as illustrated in FIGS. 4, 5. The holder 122 is bent at an angle different from that of the holder 22 such that the axis C2 of the movable electrode 12 inclines at an angle θ relative to the axis C1 of the fixed electrode 11.

The movable electrode 12 is disposed such that the electrode tip 12a of the movable electrode 12 faces the electrode tip 11a of the fixed electrode 11 on the axis C1 when the electrode tip 12a is disposed on the extended line of the axis C1 of the fixed electrode 11, and the holder 122 advances along the axis C3 by the rod portion 41 of the pressure driver 40.

The pressure driver 40, the ball spline 50, and the support member 80 of the welding gun 400 are the same as the pressure driver 40, the ball spline 50, and the support member 80 of the welding gun 100. The leading end 41a of the rod portion 41 of the pressure driver 40 is fixed to the holder 122 to be offset upward in the height direction H by the height h relative to the extended line of the axis C1.

The leading end 51a of the spline shaft 51 of the ball spline 50 is fixed to the holder 122 upward in the height direction H relative to the axis C3 to which the rod portion 41 is fixed.

The operation of the welding gun 400 will be hereinafter described. The welding gun 400 configured as described above operates similarly to the welding gun 100 of the first embodiment, and has the same effects as the welding gun 100 of the first embodiment.

In the welding gun 400, as the axis C2 of the movable electrode 12 inclines to the axis C1 of the fixed electrode 11 at an angle θ, when the rod portion 41 applies welding pressure along the axis C3 to the holder 122, the welding pressure transferred to the movable electrode 12 from the holder 122 includes a component force along the axis C2 of the movable electrode 12, and the component force includes a downward component in the height direction H, so that the electrode tip 12a of the movable electrode 12 moves downwardly from the axis C1.

That is, the welding gun 400 of the second embodiment includes the configuration that misaligns easier than that of the welding gun 100 of the first embodiment. However, the movable electrode 12 can be appropriately prevented from being misaligned by the operation of the above-described ball spline 50.

Accordingly, the welding gun 400 can appropriately apply the welding pressure generated by the pressure driver 40 to the movable electrode 12.

What is claimed is:

1. A welding gun comprising:
a fixed electrode fixed to an arm;
a movable electrode held by a holding member separated from the arm;
a pressure driver including a rod portion that is fixed to the holding member, and linearly advances and retracts, the pressure driver applying pressure to a welding target sandwiched between the movable electrode and the fixed electrode by advancing the holding member to the arm with the rod portion; and
a guide mechanism that is disposed to extend parallel to an axis of the rod portion, and guides the holding member, wherein
the rod portion is fixed to the holding member to be offset to an extended line of an axis of the fixed electrode, and
the guide mechanism includes only one guide rod fixed to any of movable portions including the movable electrode, the holding member, and the rod portion.

2. The welding gun according to claim 1, wherein the holding member is bent such that an axis of the movable electrode is disposed to be inclined to the axis of the fixed electrode.

3. The welding gun according to claim 1, wherein the guide mechanism is a ball spline.

4. The welding gun according to claim 2, wherein the guide mechanism is a ball spline.

5. The welding gun according to claim 3, wherein
the pressure driver, the guide mechanism, and the arm are fixed to a support member disposed on each of both sides of the rod portion across the axis of the rod portion, and
the support member is fixed to an attachment member that attaches the welding gun to a robot arm.

6. The welding gun according to claim 4, wherein
the pressure driver, the guide mechanism, and the arm are fixed to a support member disposed on each of both sides of the rod portion across the axis of the rod portion, and
the support member is fixed to an attachment member that attaches the welding gun to a robot arm.
